(19) United States
(12) Patent Application Publication
(10) Pub. No.: US 2010/0193730 A1
(43) Pub. Date: Aug. 5, 2010

(54) POSITIVE ELECTRODE ACTIVE MATERIAL, METHOD FOR MANUFACTURING POSITIVE ELECTRODE ACTIVE MATERIAL, LITHIUM SECONDARY BATTERY, AND METHOD FOR MANUFACTURING LITHIUM SECONDARY BATTERY

(75) Inventor: Hideyuki Yamamura, Susono-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi, Aichi-ken (JP)

(21) Appl. No.: 12/679,733

(22) PCT Filed: Sep. 26, 2008
(86) PCT No.: PCT/IB08/03077

§ 371 Date: Mar. 24, 2010

(30) Foreign Application Priority Data
Sep. 27, 2007 (JP) 2007-250932

(51) Int. Cl. H01M 4/00

(52) U.S. Cl. 252/182.1

(57) ABSTRACT

A method for manufacturing positive electrode active material includes: forming a fluorine-based coat film on a surface of a positive electrode active material by subjecting the positive electrode active material to a fluorine treatment; and forming a fluorine-oxygen-containing active material layer that contains fluorine and oxygen on the surface of the positive electrode active material by firing the fluorine-based coat film under an oxygen atmosphere.

### BACKGROUND OF THE INVENTION

1. Field of the Invention

The invention relates to a positive electrode active material, a method for manufacturing the positive electrode active material, a lithium secondary battery, and a method for manufacturing the lithium secondary battery.

2. Description of the Related Art

Along the trend of size reduction of personal computers, video cameras, cellular phones, etc., the field of information-related appliances and communication appliances is seeing the practical and wide-spread use of lithium secondary batteries as power sources used for these appliances for the reason that the lithium secondary batteries are high in energy density. Besides, in the field of motor vehicles, the development of electric motor vehicles is being hastened due to environmental issues and resource issues. A lithium secondary battery is also considered as a power source of the electric motor vehicles.

However, presently commercially available lithium secondary batteries employ an organic electrolyte solution whose solvent is an organic solvent. In such a lithium secondary battery, the positive electrode active material and the electrolyte liquid contact and react. Therefore, as the charging and discharging cycle is repeated, both the positive electrode active material and the electrolyte liquid gradually degrade, and therefore there is a problem of decreases in the quantity of electricity to be charged and discharged and therefore declines of the cycle characteristics.

Therefore, in order to improve the durability and the cycle characteristics of the lithium secondary battery, for example, Japanese Patent Application Publication No. 2004-192896 (JP-A-2004-192896) discloses a positive electrode active material whose active material surface has been subjected to a fluorine treatment. In this treatment, an outermost surface of the positive electrode active material is subjected to fluorine substitution, so that the reaction activity of the positive electrode active material with an electrolyte solution at high temperature can be restrained. However, the fluorine treatment inhibits the paths of electron conduction in the active material surface, and therefore deteriorates electron conductivity. As a result of this, the internal resistance of the battery becomes high, and the insertion and desorption of lithium ions in the positive electrode at the time of discharge becomes difficult, or the migration of lithium ions becomes difficult, thus giving rise to a problem of decline of the output characteristics of the lithium secondary battery.

### SUMMARY OF THE INVENTION

The invention provides a positive electrode active material, a method for manufacturing the positive electrode active material, a lithium secondary battery, and a method for manufacturing the lithium secondary battery in which the cycle characteristics of the lithium secondary battery is improved and the output characteristics thereof is improved.

A first aspect of the invention is a method for manufacturing positive electrode active material that includes: forming a fluorine-based coat film on a surface of a positive electrode active material by subjecting the positive electrode active material to a fluorine treatment; and forming a fluorine-oxygen-containing active material layer that contains fluorine and oxygen on the surface of the positive electrode active material by firing the fluorine-based coat film under an oxygen atmosphere.

In the foregoing method, the positive electrode active material containing oxygen may be subjected to the fluorine treatment.

The fluorine-based coat film may be subjected to an oxidized fire treatment at a predetermined temperature with an oxidative gas.

The oxidative gas may be an oxygen gas that has a partial pressure within a range of 10 to 30%.

The predetermined temperature may be within a range of 600 to 800° C.

The positive electrode active material may be subjected to the fluorine treatment by using a fluorine (F₂) gas.

Partial pressure of the fluorine gas may be within a range of 3 to 7%.

The positive electrode active material containing oxygen may be LiₓMO_{y}, where M represents a transition metal, and x is within a range of 0.02 to 2.2, and y is within a range of 1.4 to 3.

The M may include at least one species of Co, Ni and Mn.

A second aspect of the invention is a positive electrode active material obtained by the foregoing method for manufacturing positive electrode active material.

A third aspect of the invention is a method for manufacturing lithium secondary battery that includes forming a positive electrode body with a positive electrode active material obtained by the foregoing method for manufacturing positive electrode active material.

A fourth aspect of the invention is a lithium secondary battery obtained by the foregoing method for manufacturing lithium secondary battery.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a manufacture flowchart showing an example of the method for manufacturing a fluorine-oxygen-containing active material layer-coated positive electrode active material of the invention;

FIG. 2 is a schematic general sectional view showing an example of a fluorine-coated positive electrode active material in the invention;

FIG. 3 is a schematic general sectional view showing an example of fluorine-oxygen-containing active material layer-coated positive electrode active material obtained in the invention;

FIG. 4 is a schematic general sectional view showing an example of a pre-fluorine-treatment state of the surface of the positive electrode active material used in the invention;

FIG. 5 is a schematic general sectional view showing an example of the state of the surface of a fluorine-coated positive electrode active material in the invention;

FIG. 6 is a schematic general sectional view showing an example of the state of the surface of the fluorine-oxygen-containing active material layer-coated positive electrode active material;

FIG. 7 is a general sectional view schematically showing an example of a lithium secondary battery obtained in the invention; and

FIG. 8 is a graph showing number-of-cycle-dependent changes in the discharge maintenance rate of the coin cells obtained in a working example, Comparative Example 1, and Comparative Example 2.

### DETAILED DESCRIPTION OF EMBODIMENTS

Embodiments of the positive electrode active material, the method for manufacturing the positive electrode active material, and the lithium secondary battery of the invention will be described below.

First, a method for manufacturing a positive electrode active material will be described. In the method for manufacturing the positive electrode active material according to the embodiment of the invention, a positive electrode active material is subjected to a fluorine treatment so as to form a fluorine-based coat film on a positive electrode active material surface. After that, the fluorine-based coat film is fired under an oxygen atmosphere, whereby a fluorine-oxygen-containing active material layer that contains fluorine and oxygen is formed on the positive electrode active material surface.

According to this embodiment of the invention, the fluorine in the fluorine-oxygen-containing active material layer coating a surface of the positive electrode active material containing at least oxygen (hereinafter, sometimes referred to as “oxygen-containing positive electrode active material”) restrains the deterioration of the positive electrode active material that is caused by the reactions of the positive electrode active material with the electrolyte solution and the like, and therefore improves the cycle characteristics. Furthermore, the fluorine and the oxygen in the active material layer serve as paths of electron conduction and therefore improves the electron conductivity, and therefore makes it possible to lessen the internal resistance of the battery and the like, and achieve sufficient conduction of lithium ions in the positive electrode and the like at the time of discharge. Thus, this embodiment enables to obtain a positive electrode active material whose output characteristics are improved.

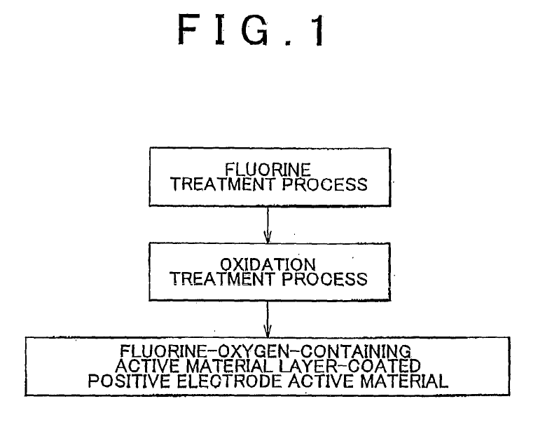

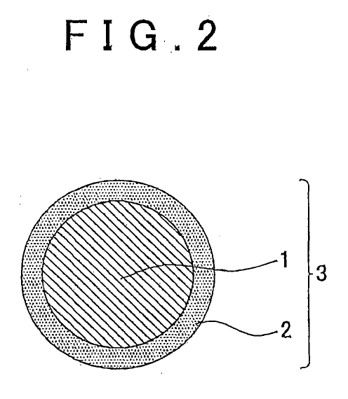

FIG. 1 shows a flow of a method for manufacturing a positive electrode active material according to an embodiment of the invention (i.e., a flowchart of the manufacture of a fluorine-oxygen-containing active material layer-coated positive electrode active material). As shown in FIG. 1, firstly, in a fluorine treatment process, a fluorine-based coat film is formed on a positive electrode active material surface by, for example, exposing, the surface to a fluorine gas for a predetermined time, whereby a fluorine-coated positive electrode active material 3 in which a fluorine-based coat film 2 is formed on the surface of a positive electrode active material 1 as exemplified in a schematic general sectional view in FIG. 2 can be obtained.

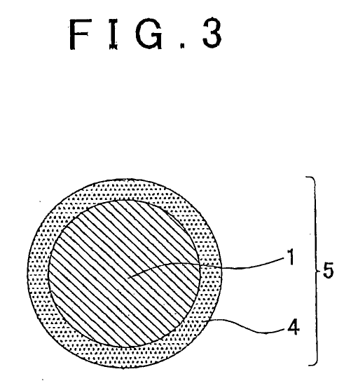

After the fluorine treatment process, an oxidized fire treatment process is performed. By firing the fluorine-based coat film under an oxygen atmosphere, a fluorine-oxygen-containing active material layer that contains fluorine an oxygen is formed in the positive electrode active material surface, so that a fluorine-oxygen-containing active material layer-coated positive electrode active material 5 in which a fluorine-oxygen-containing active material layer 4 that contains fluorine and oxygen is formed on the surface of the positive electrode active material 1 as exemplified in a schematic general sectional view of FIG. 3 is obtained.

With regard to the fluorine-oxygen-containing active material layer, the following speculation can be made. As the fluorine-based coat film merely with fluorine adhered to the positive electrode active material surface is fired under the oxygen atmosphere, fluorine and oxygen are introduced into an amorphous structure of a surface portion of the positive electrode active material. The fluorine introduced into the inside of the amorphous structure restrains the deterioration of the positive electrode active material caused by the reactions thereof with the electrolyte solution and the like, and therefore improves the cycle characteristics, and improves the electron conductivity as well. Furthermore, the oxygen introduced into the inside of the amorphous structure also serves as a path of electron conduction, and therefore can also improve the electron conductivity and lessen the internal resistance of the battery and like. Therefore, the cycle characteristics can be improved, and the output characteristics can be improved.

The method for manufacturing a positive electrode active material having a coat of a fluorine-oxygen-containing active material layer is not particularly limited as long as the method includes at least a fluorine treatment process in which the positive electrode active material is subjected to a fluorine treatment, so that a fluorine-based coat film is formed on a positive electrode active material surface, and an oxidized fire treatment process in which a fluorine-oxygen-containing active material layer that contains fluorine and oxygen is formed on the positive electrode active material surface by firing the fluorine-based coat film obtained by the fluorine treatment process under an oxygen atmosphere. Hereinafter, each of the processes of the method for manufacturing the positive electrode active material according to the embodiment of the invention will be described in detail.

Firstly, the fluorine treatment process will be described. The fluorine treatment process in the embodiment of the invention is a process in which a fluorine-coated positive electrode active material in which a fluorine-based coat film is formed on a positive electrode active material surface by the fluorine treatment of the oxygen-containing positive electrode active material.

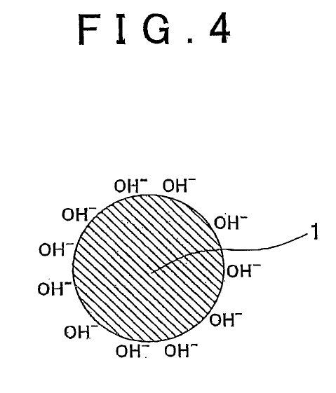

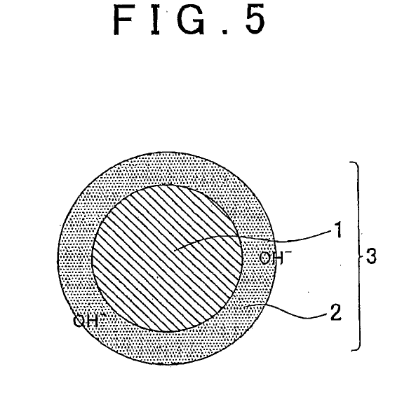

Through the fluorine treatment process, a fluorine-coated positive electrode active material in which a fluorine-based coat film is formed on a positive electrode active material surface by performing the fluorine treatment on the oxygen-containing positive electrode active material. A reason for this can be assumed to be as follows. Specifically, as exemplified in a schematic general sectional view in FIG. 4, prior to the fluorine treatment, inert substances such as hydroxide ions (OH⁻) are being adhered to the surface of the positive electrode active material 1. The fluorine treatment on the positive electrode active material surface enables to replace the hydroxide ions (OH⁻) adhered to the surface with fluorine (F), so that, as exemplified in a schematic general sectional view in FIG. 5, a fluorine-based coat film 2 in which F is adhered to the surface of the positive electrode active material 1 is formed. In this manner, a fluorine-coated positive electrode active material 3 as shown in FIG. 5 can be obtained. On the other hand, some hydroxide ions (OH⁻) having not been substituted with fluorine (F) during the fluorine treatment, may still remain in the fluorine-based coat film 2 on the surface of the positive electrode active material 1.

The method of the fluorine treatment in this embodiment is not particularly limited as long as the method is able to form a fluorine-based coat film on the positive electrode active material surface. For example, a method in which the fluorine treatment is performed by using a pyrolysis gas such as F₂ gas, NF₃ gas, etc. may be used. Besides, the fluorine treatment may also be carried out by mixing a predetermined positive electrode active material and lithium carbonate, and using an electrolyte solution that contains a predetermined amount of hydrogen fluoride to react the lithium carbonate with the hydrogen fluoride contained in the electrolyte solution. Furthermore, the fluorine treatment may also be carried out by providing a predetermined amount of fluorine in some manner, for example, by mixing LiF into a raw material at the time of synthesizing a positive electrode active material, and then firing the positive electrode active material. In particular, the methods in which the fluorine treatment is performed by using a pyrolysis gas such as F₂ gas, NF₃ gas, etc. are preferable. This is because if this method is used, a fluorine-based coat film in which fluorine is adhered to the positive electrode active material surface is stably and uniformly formed only on the surface of the material. Particularly, the method in which the fluorine treatment is performed by using F₂ gas is preferable. Since the activity of F₂ gas is high, the treatment can be accomplished in a short time at relatively low temperature, and therefore the manufacturing cost can be curbed. Besides, the fluorine gas used in the foregoing method may be a mixture gas such as a fluorine/argon mixture gas or the like. It is also permissible to use a method in which a predetermined amount of pure fluorine gas is implanted under reduced pressure.

The degree of the fluorine treatment if performed is not particularly limited, that is, any degree suffices as long as a sufficient degree of the fluorine treatment to the positive electrode active material surface is obtained and, after the below-described oxidized fire treatment, the reaction between the electrolyte solution and the positive electrode active material surface is restrained so as to improve the cycle characteristics. The degree of the fluorine treatment can be controlled as desired by adjusting the gas partial pressure of the process gas, the process temperature, or the process time.

In the case where the process gas is a fluorine gas, the fluorine gas partial pressure in the process gas is preferably, for example, 1% or higher, and, in particular, in the range of 3 to 7%. If the partial pressure of the fluorine gas is excessively low, there is a risk that a sufficient fluorine treatment cannot be performed. If the fluorine gas partial pressure is set in the range mentioned above, a sufficient fluorine treatment to the positive electrode active material surface is realized, and, after the performance of the below-described oxidized fire treatment, the reaction between the electrolyte solution and the positive electrode active material surface is restrained, so that the deterioration of the, electrolyte solution and the positive electrode active material surface can be restrained, and therefore the cycle characteristics can be improved.

Besides, in the case where the process gas is a fluorine gas, the process temperature following the implantation of the fluorine gas is preferably the normal temperature or higher. This temperature allows the fluorine treatment to the positive electrode active material surface to promptly proceed and be completed.

Besides, in the case where the process gas, is a fluorine gas, the process time following the implantation of the fluorine gas is preferably, for example, in the range of 0.1 minute to 5 hours, and, in particular, in the range of 0.5 minute to 5 minutes. If the process time is excessively short, there is a risk that a sufficient fluorine treatment cannot be performed. If the process time is within the foregoing range, a sufficient fluorine treatment to the positive electrode active material surface can be performed.

Incidentally, in this embodiment of the invention, it can be checked whether or not the positive electrode active material surface is coated with the fluorine-based coat film, for example, by suspending in water an active material with a fluorine-based coat film formed thereon, and measuring the fluorine ion concentration by a fluorine ion meter.

The oxygen-containing positive electrode active material used in the embodiment is not particularly limited as long as the material is able to store and release lithium ions, and contains oxygen. Examples of the oxygen-containing positive electrode active material include metal oxides containing Li, metal phosphides containing Li and oxygen, metal borides containing Li and oxygen, etc. In particular, it is preferable to use an oxygen-containing positive electrode active material represented by a general formula LiₓMO_{y}. In the formula, M is made up of mainly of a transition metal, and contains at least one species of Co, Mn, Ni, V, and Fe. Besides, in the formula, the ranges of the values of x and y are x=0.02 to 2.2 and y=1.4 to 3. In particular, oxygen-containing positive electrode active materials containing at least one species of Co, Ni and Mn are preferable.

Next, the oxidized fire treatment process in the embodiment of the invention will be described. The oxidized fire treatment process in the embodiment of, the invention is a process of obtaining a fluorine-oxygen-containing active material layer-coated positive electrode active material in which fluorine and oxygen are introduced into the inside of an amorphous structure of an oxygen-containing positive electrode active material surface portion so that a fluorine-oxygen-containing active material layer is formed, by firing under an oxygen atmosphere the fluorine-based coat film obtained in the foregoing fluorine treatment process.

Through the oxidized fire treatment process, the fluorine-oxygen-containing active material layer is formed in the oxygen-containing positive electrode active material surface portion, so that a fluorine-oxygen-containing active material layer-coated positive. electrode active material can be obtained. The reason can be assumed as follows. That is, as exemplified in a schematic general sectional view in FIG. 5, in the fluorine-coated positive electrode active material obtained by the foregoing fluorine treatment process, a fluorine-based coat film is mainly formed of fluorine adhered to the surface of the positive electrode active material 1. It is speculated that the oxidized fire treatment performed on the fluorine-coated positive electrode active material causes the following phenomenon. That is, the oxygen atmosphere in the oxidized fire treatment enable to remove OH⁻ remaining in the fluorine-based coat film, and thus replace the fluorine merely adhered to the positive electrode active material surface contained in the fluorine-based coat film with oxygen being present under the oxygen atmosphere.

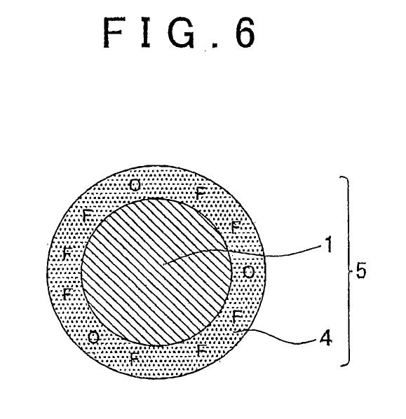

Furthermore, due to the firing at high temperature, oxygen and fluorine are introduced into the inside of the amorphous structure of the oxygen-containing positive electrode active material surface. Therefore, a positive electrode active material 5 having a coat of a fluorine-oxygen-containing active material layer as exemplified in a schematic general sectional view in FIG. 6 can be obtained in which fluorine and oxygen are introduced into the inside of the amorphous structure of the surface portion of the positive electrode active material 1 so that a fluorine-oxygen-containing active material layer 4 is formed. Besides, in the fluorine-oxygen-containing active material layer 4 on the surface of the positive electrode active material 1 which is formed through the oxidized fire treatment, the fluorine-based coat film in which fluorine is adhered to the surface of the positive electrode active material 1 sometimes remains.

Incidentally, the method of performing the oxidized fire treatment is not particularly limited as long as the method is able to introduce fluorine and oxygen into the inside of the amorphous structure of the positive electrode active material surface portion so as to form a fluorine-oxygen-containing active material layer by performing the oxidized fire treatment on the fluorine-based coat film. Examples of the method of performing the oxidized fire treatment include a method in which the oxidized fire treatment is performed at a predetermined temperature by using an oxidative gas that has oxidizing power, a method in which the oxidized fire treatment is performed at a predetermined temperature in the atmospheric air. In particular, the method in which the oxidized fire treatment is performed at a predetermined temperature by the oxidative gas is preferable. This method is able to cause the oxidized fire treatment to promptly proceed and be completed.

The oxidative gas used in this process is preferably oxygen gas. The oxygen gas is commonly used, and is high in general versatility. Besides, in the case where the oxidative gas is used in the oxidized fire treatment process, it is preferable to perform the oxidized fire treatment while circulating the oxidative gas in a tightly closed container. The circulation of the oxidative gas removes the OH⁻ remaining in the fluorine-based coat film, and accelerates substitution of the fluorine merely adhered to the positive electrode active material surface in the fluorine-based coat film, with oxygen being present under the oxygen atmosphere, so as to cause the oxidized fire treatment to promptly proceed and be completed.

The degree of the oxidized fire treatment if performed is not particularly limited, that is, any degree suffices as long as fluorine and oxygen are introduced into the inside of the amorphous structure of the positive electrode active material surface portion so that the a desired fluorine-oxygen-containing active material layer can be formed. The degree of the oxidized fire treatment can be controlled as desired by adjusting the gas partial pressure of the process gas, the firing temperature, or the firing time.

In the case where the process gas is an oxygen gas, it is preferable that the oxygen gas partial pressure in the process gas be, for example, 5% or higher, and, in particular, in the range of 10 to 30%. If the partial pressure of the oxygen gas is below the foregoing range, the removal of OH⁻ remaining in the fluorine-based coat film, the substitution of the fluorine in the fluorine-based coat film with oxygen being present under the oxygen atmosphere, etc., are prevented from proceeding in good manner, so that the paths of electron conduction provided by oxygen and fluorine cannot be secured, and the conduction of lithium ions cannot be sufficiently achieved, thus giving rise to a risk of failing to improving the output characteristics. On the other hand, if the oxygen gas partial pressure is above the foregoing range, the amount of fluorine excessively decreases, or the like, so that the deterioration of the positive electrode active material caused by the reaction with the electrolyte solution and the like cannot be restrained, thus giving rise to a risk of it becoming difficult to, improve the cycle characteristics.

The firing temperature at which the firing is performed varies depending on the kind of the process gas and the like, and is not particularly limited as long as the firing temperature allows oxygen and fluorine to be introduced into the inside of the amorphous structure of the oxygen-containing positive electrode active material surface and form the fluorine-oxygen-containing active material layer. It is preferable that the firing temperature be, for example, 600° C. or higher, and, in particular, within the range of 600 to 800° C. If the firing temperature is below the foregoing range, there arises a risk that sufficient introduction of the ‘oxygen and fluorine into the inside of the amorphous structure of the oxygen-containing positive electrode active material surface cannot be achieved and therefore the fluorine-oxygen-containing active material layer cannot be formed. On the other hand, if the firing temperature is above the foregoing range, there arises a risk that the desired positive electrode active material cannot be obtained due to excessive introduction of oxygen and fluorine into the oxygen-containing positive electrode active material, or the like.

Besides, the firing time, that is, the length of time during which the firing is performed, varies depending on the kind of the process gas and the like, and is not particularly limited as long as the firing time allows oxygen and fluorine to be introduced into the inside of the amorphous structure of the oxygen-containing positive electrode active material surface and form the fluorine-oxygen-containing active material layer. It is preferable that the firing time be, for example, 5 hours, and, in particular, within the range of 8 to 15 hours. If the firing time is excessively short, there arises a risk that sufficient introduction of oxygen and fluorine into the inside of the amorphous structure of the oxygen-containing positive electrode active material surface cannot be achieved and therefore the fluorine-oxygen-containing active material layer cannot be formed. On the other hand, if the firing time is longer than the foregoing range, there arises a risk that the desired positive electrode active material cannot be obtained due to excessive introduction of oxygen and fluorine into the oxygen-containing positive electrode active material, or the like.

Incidentally, in the embodiment of the invention, whether or not the fluorine-oxygen-containing active material layer has been formed on the positive electrode active material surface can be checked by comparing the fluorine ion concentration measured by a fluorine ion meter in an aqueous suspension of an active material coated with a fluorine-oxygen-containing active material layer and the fluorine ion concentration measured by the fluorine ion meter in an aqueous suspension of an active material having merely a fluorine-based coat film which has not been subjected to the oxidized fire treatment.

The positive electrode active material herein is the same as the positive electrode active material described above, and is omitted from the description herein.

The use of the fluorine-oxygen-containing active material layer-coated positive electrode active material obtained by the embodiment of the invention is not particularly limited. For example, the material can be used as a positive electrode active material for use in a lithium secondary battery, and, the like. In particular, the use as a positive electrode active material for use in a lithium secondary battery for motor vehicles is preferable.

Next, the method for manufacturing a lithium secondary battery of the embodiment of the invention will be described in detail below. The method for manufacturing the lithium secondary battery of the embodiment of the invention has a process of fabricating a positive electrode body by using the foregoing fluorine-oxygen-containing active material layer-coated positive electrode active material. For example, first, using the fluorine-oxygen-containing active material layer-coated positive electrode active material, a positive electrode layer is fabricated on a positive electrode current collector, and a positive electrode body made up of the positive electrode layer and the positive electrode current collector is fabricated. Next, a negative electrode layer is fabricated on a negative electrode current collector, and a negative electrode body made up of the negative electrode layer and the negative electrode current collector is fabricated. After that, the positive electrode body and the negative electrode body are placed together with a predetermined separator so that the separator is sandwiched by the positive electrode layer and the negative electrode layer. Then, a battery assembly process of packing a predetermined electrolyte in the positive electrode layer, the negative electrode layer and the separator and then inserting into a battery case or the like a subassembly in which the separator is sandwiched by the positive electrode body and the negative electrode body is performed. Thus, a desired lithium secondary battery as described above can be obtained. Incidentally, the manufacture processes for the positive electrode body and the negative electrode body may be simultaneously performed. Alternatively, the manufacture process for the positive electrode body may be performed after the manufacture process for the negative electrode body.

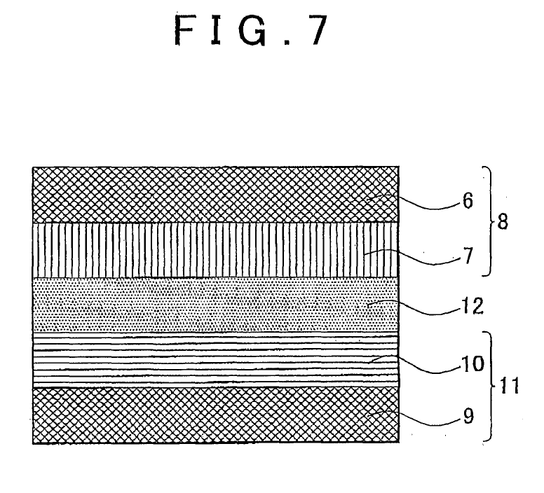

According to the embodiment of the invention, since a fluorine-oxygen-containing active material layer-coated positive electrode active material with improved cycle characteristics and improved output characteristics which is obtained by the foregoing method for manufacturing the fluorine-oxygen-containing active material layer-coated positive electrode active material is used, a lithium secondary battery with improved cycle characteristics and improved output characteristics can be obtained. Next, a lithium secondary battery obtained by the embodiment of the invention will be described with reference to drawings. FIG. 7 is a general sectional view schematically showing an example of the lithium secondary battery obtained by the embodiment of the invention. The lithium secondary battery shown in FIG. 7 has a positive electrode body 8 that is made up of a positive electrode current collector 6 and a positive electrode layer 7 that contains a fluorine-oxygen-containing active material layer-coated positive electrode active material (not shown), and a negative electrode body 11 made up of a negative electrode current collector 9 and a negative electrode layer 10 that contains a negative electrode active material (not shown), a separator 12 disposed between the positive electrode body 8 and the negative electrode body 11, and an electrolyte (not shown) containing a lithium, salt which is packed in the positive electrode layer 7, the negative electrode layer 10 and the separator 12.

The method for manufacturing the lithium secondary battery of the embodiment of the invention is not particularly limited as long as the method has the positive electrode body manufacture process. The method for manufacturing the lithium secondary battery of the embodiment of the invention will be described below in detail with respect to each of the processes.

The positive electrode body manufacture process in the embodiment of the invention is a process in which, using the above-described fluorine-oxygen-containing active material layer-coated positive electrode active material, a positive electrode layer is fabricated on the positive electrode current collector, and a positive electrode body made up of the positive electrode layer and the positive electrode current collector is fabricated. Concretely, the method of the positive electrode body manufacture process is not particularly limited as long as the method is able to fabricate a positive electrode body in which a positive electrode layer having the foregoing fluorine-oxygen-containing active material layer-coated positive electrode active material is fabricated on the positive electrode current collector. For example, after a solution is obtained by solving a predetermined binder material in a predetermined solvent, the fluorine-oxygen-containing active material layer-coated positive electrode active material and a predetermined electro-conductive agent are introduced into the solution, and then the mixture is kneaded homogeneously to fabricate a paste for forming a positive electrode layer. The positive electrode layer-purpose paste is applied to one side of a predetermined positive electrode current collector. After the drying, the pressing and the like are performed, the positive electrode current collector is cut into a predetermined size or the like, thus fabricating a positive electrode body. Then, this positive electrode body is placed on one side of a separator. This method may be cited as an example of the positive electrode body manufacture process, along with other methods and the like.

The positive electrode body used in the embodiment of the invention is made up of at least a positive electrode current collector, a positive electrode layer containing the fluorine-oxygen-containing active material layer-coated positive electrode active material, and an electrolyte. The fluorine-oxygen-containing active material layer-coated positive electrode active material herein is the same as is described above, and is omitted from the description herein.

The positive electrode layer ordinarily contains a conductive material, and a binder material. Examples of the conductive material include carbon black, acetylene black, etc. The binder material is not particularly limited as long as it is a binder material that is generally used in lithium secondary batteries. Concrete examples of the binder material include a polyvinylidene fluoride (PVDF), a polytetrafluoroethylene (PTFE), an ethylene tetrafluoroethylene (ETFE), a fluorine-based resin, etc.

The positive electrode current collector performs the collection of current with respect to the positive electrode layer. The material of the positive electrode current collector is not particularly limited as long as it has electro-conductivity. Examples of the material include aluminum, SUS, nickel, iron, titanium, etc. In particular, aluminum and SUS are preferable. The positive electrode current collector may be a dense metal current collector, or may also be a porous metal current collector.

Besides, the solvent used in the positive electrode body manufacture process is not particularly limited as long as the solvent allows a desired positive electrode layer-purpose paste as described above to be obtained. Examples of the solvent include n-methylpyrrolidone, and the like.

The method for manufacturing the lithium secondary battery of the embodiment of the invention is not particularly limited as long as the method has at least the positive electrode body manufacture process. Usually, in addition to the positive electrode body manufacture process, the method for manufacturing the lithium secondary battery has a process of fabricating a negative electrode body made of a negative electrode layer and a negative electrode current collector, and a battery assembly process of placing the positive electrode body and the negative electrode body so that a predetermined separator is sandwiched between the positive electrode layer and the negative electrode layer, and then packing a predetermined electrolyte in the positive electrode layer, the negative electrode layer and the separator, and then inserting, into a battery case or the like, a subassembly in which the separator is sandwiched by the positive electrode body and the negative electrode body. These processes are the same as the processes performed to provide a common lithium secondary battery, and are omitted from the description herein.

Next, the negative electrode body, the separator, the electrolyte, the battery case, etc. that are used in the negative electrode body manufacture process or the battery assembly process will be described. The negative electrode body used in the embodiment of the invention is made up of at least a negative electrode current collector, a negative electrode layer containing a negative electrode active material, and an electrolyte. The negative electrode active material is not particularly limited as long as the material capable of storing and releasing lithium ions. Examples of the negative electrode active material include metallic lithium, lithium alloys, metal oxides, metal sulfides, metal nitrides, and carbon-based materials such as graphite and the like. In particular, graphite is preferable.

The negative electrode layer may contain a conductive material, and a binder material, according to the needs. The conductive material and the binder material used herein may be the same as those used in the positive electrode layer.

Besides, the negative electrode current collector performs the collection of current with respect to the negative electrode layer. The material of the negative electrode current collector is not particularly limited as long as the material has electro-conductivity. Examples of the material include copper, stainless steel, nickel, etc. In particular, copper is preferable. The aforementioned negative electrode current collector may be a dense metal current collector, or may also be a porous metal current collector.

The separator used in the embodiment of the invention is disposed between the positive electrode layer and the negative electrode layer, and has a function of retaining an electrolyte as described above. The material of the separator is not particularly limited. Examples of the material include resins such as polyethylene (PE), polypropylene (PP), polyester, cellulose, polyimide, etc. In particular, polypropylene is preferable. Besides, the separator may have a single-layer structure or may also have a multi-layer structure. Examples of the multi-layer structure separator include separators of a two-layer structure of PE/PP, separators of three-layer structure of PP/PE/PP, etc. Furthermore, in the embodiment of the invention, the separator may be made of a porous membrane, or a non-woven fabric such as a resin non-woven fabric or a glass fiber non-woven fabric or the like, etc.

In the lithium secondary battery obtained in accordance with the example embodiment of the embodiment of the invention, an electrolyte containing a lithium salt is introduced in the positive electrode layer, the negative electrode layer and the separator. Concretely, this electrolyte may be in a liquid state, or may also be in a gel state, and may be appropriately selected according to the kind of a desired battery. In particular, the electrolyte in a liquid state is preferable. The electrolyte in a liquid state provides a better lithium ion conductivity. In the case where the electrolyte is in a liquid state, a nonaqueous electrolyte solution is conceivable. The nonaqueous electrolyte solution provides a better lithium ion conductivity. The nonaqueous electrolyte solution ordinarily has a lithium salt and a nonaqueous solvent. The lithium salt is not particularly limited as long as it is a lithium salt generally used in lithium secondary batteries. Examples of the lithium salt include LiPF₆, LiBF₄, LiN(CF₃SO₂)₂, LiCF₃SO₃, LiC₄F₉SO₃, LiC(CF₃SO₂)₃, LiClO₄, etc. The nonaqueous solvent, on the other hand, is not particularly limited as long as it is capable of dissolving the foregoing lithium salt.

Examples of the nonaqueous solvent include propylene carbonate, ethylene carbonate, diethyl carbonate, dimethyl carbonate, ethyl methyl carbonate, 1,2-dimethoxyethane, 1,2-diethoxyethane, acetonitrile, propionitrile, tetrahydrofuran, 2-methyltetrahydrofuran, dioxane, 1,3-dioxolan, nitromethane, N,N-dimethyl formamide, dimethyl sulfoxide, sulfolan, γ-butyrolactone, etc. In the embodiment of the invention, only one species of these nonaqueous solvents may be used, or a mixture of two or more species thereof may also be used. Besides, the nonaqueous electrolyte solution used herein may be an ambient temperature molten salt.

In the lithium, secondary battery obtained in the embodiment of the invention, the lithium secondary battery as shown in FIG. 7 is inserted into a battery case, and an opening rim is worked to close the opening. Thus, the lithium secondary battery is fabricated. The battery case used herein is generally a metal-made case, and examples thereof include a stainless-steel-made case, and the like. Besides, the shape of the battery case used in the embodiment of the invention is not particularly limited as long as the battery case is capable of housing the foregoing separator, the foregoing positive electrode body, the foregoing negative electrode body, and so on. Concretely, examples of the shape of the battery case include a cylindrical shape, a square shape, a coin shape, a laminate shape, etc.

The use of the lithium secondary battery obtained in the embodiment of the invention is not particularly limited. For example, the lithium secondary battery of the embodiment of the invention can be used as a lithium secondary battery for a motor vehicle, and the like.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the claimed invention.

The embodiment of the invention will be further concretely described with reference to examples.

As a working example of the embodiment of the invention, after a positive electrode active material (LiCoO₂) was sealed in a gas-tight container, and was degassed, a fluorine treatment in which a fluorine (F₂) gas (fluorine gas partial pressure of 5%) was injected into the container, and the container was let to stand for one minute so as to form a fluorine-based coat film on the surface of the positive electrode active material (LiCoO₂) was performed, whereby a fluorine coat LiCoO₂ was obtained. After that, the fluorine-coated positive electrode active material obtained by the fluorine-coated positive electrode active material manufacture procedure was sealed in a gas-tight container and was degassed. Then, an oxidized fire treatment in which the active material was fired under the atmospheric atmosphere at 760° C. for 12 hours so as to form a fluorine-oxygen-containing active material layer containing fluorine and oxygen, on the positive electrode active material surface was performed, whereby a fluorine-oxygen-containing active material layer coat LiCoO₂ was obtained. After that, the fluorine-oxygen-containing active material layer coat LiCoO₂ obtained by the fluorine-oxygen-containing active material layer-coated positive electrode active material manufacture procedure and an electro-conductive auxiliary agent (acetylene black, made by Denki Kagaku Kogyo Company) were mixed so that the mass ratio therebetween became 85:15. The mixture was then mixed and grounded by using an agate mortar, whereby a powder resistance evaluation sample was obtained.

Incidentally, in order to fabricate the positive electrode body, 286 g of the fluorine-oxygen-containing active material layer coat LiCoO₂ powder obtained by the fluorine-oxygen-containing active material layer-coated positive electrode active material manufacture procedure and 33 g of acetylene black were added into 300 mL of a solvent NMP solution in which a binder, polyvinylidene fluoride (PVDF) has been dissolved by 12.8 wt %, and the mixture was kneaded until it was homogeneously mixed. Thus, a positive electrode layer-purpose paste was fabricated. The positive electrode layer-purpose paste was applied to one side of a 15-μm-thick Al current collector, which was then dried. Thus, a positive electrode body was fabricated. The electrode amount per unit area was 13 mg/cm². This positive electrode body was pressed to a positive electrode layer-purpose paste thickness of 74 μm and a positive electrode layer-purpose paste density of 2.45 g/cm³. After that, the positive electrode body was cut out into a size of φ16 mm, whereby a positive electrode body was obtained.

The negative electrode body was obtained by cutting out a Li metal into a size of φ19 mm.

In order to fabricate coin cells, the positive electrode and the negative electrode described above, and a PE-made separator were used. Thus, CR2032 type coin cells were fabricated. An electrolyte solution obtained by dissolving LiPF₆ as a supporting electrolyte to a concentration of 1 mol/L in a mixture obtained by mixing EC and DMC at a volume ratio of 3:7.

Hereinafter, Comparative Example 1 will be described. Powder resistance evaluation samples and coin cells were fabricated substantially in the same manner as in Example 1 described above, except that, as the positive electrode active material, LiCoO₂ obtained without the fluorine treatment and the oxidized fire treatment performed thereon was used instead of the fluorine-oxygen-containing active material layer-coated positive electrode active material.

Hereinafter, Comparative Example 2 will be described. Powder resistance evaluation samples and coin cells were fabricated substantially in the same manner as in Example 1 described above, except that, as the positive electrode active material, LiCoO₂ obtained by performing only the fluorine treatment, that is, the process preceding the oxidized fire treatment of the fluorine-coated positive electrode active material manufacture procedure, was used instead of the fluorine-oxygen-containing active material layer-coated positive electrode active material.

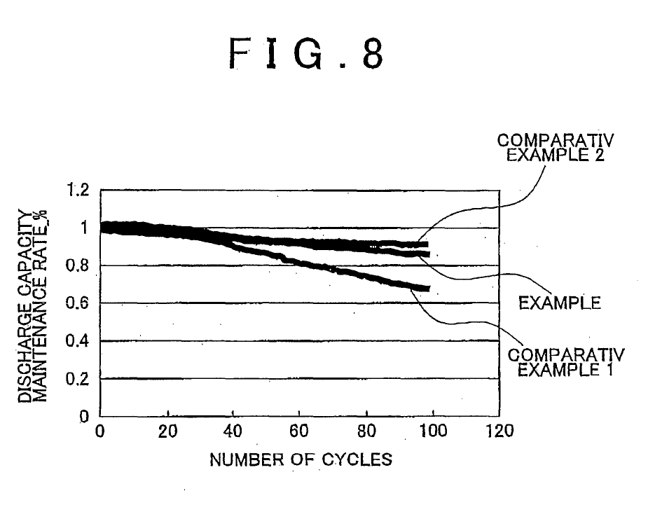

Evaluations for powder resistance measurements will be described below. The powder resistance evaluation samples obtained as a result of the foregoing working example, Comparative Example 1 and Comparative Example 2 were respectively weighed by 0.5 gram, and placed in a powder resistance measurement cell. Next, the samples were pressed at 250 kgf/cm² by using a hand press, and the resistance at the time of pressing was measured three times by a tester for each sample. Obtained results are shown in Table 1. Also, a test for the cycle characteristics was performed with the coin cells obtained as result of the foregoing working example, Comparative Example 1 and Comparative Example 2. For the cycle characteristics, the test of 10 cycles was carried out under the condition of 3.1 to 4.2V, 25° C., and 1/2 C. Assuming that the initial discharge capacity is “1”, a discharge capacity maintenance rate following 100 cycles was calculated. Obtained results are shown in FIG. 8.

TABLE 1

| | Powder resistance |
|---|---|
| | (mΩ) |
| Working Example | 66, 63, 67 |
| Comparative Example 1 | 64, 62, 63 |
| Comparative Example 2 | 71, 74, 69 |

As shown in Table 1, the powder resistances were 66, 63 and 67 mΩ in the working example, which was subjected to the oxidized fire treatment, and 64, 62, 63 mΩ in Comparative Example 1, which was not subjected to the fluorine treatment, and were 71, 74, and 69 mΩ in Comparative Example 2, which was not subjected to the fluorine treatment. Thus, the powder resistance according to the working example was slightly larger than that of Comparative Example 1, whereas being smaller than that of Comparative Example 2. From these results, according to the working example, it was confirmed that the performance of the oxidized fire treatment following the fluorine treatment provided a fluorine-oxygen-containing active material layer coat LiCoO₂ in which fluorine and oxygen were introduced into the LiCoO₂ active material surface so as to become paths of electron conduction, and the electron conductivity was improved and the internal resistance of the battery was lessened, and sufficient conduction of lithium ions was achieved.

As shown in FIG. 8, results of the cycle test show that the post-100-cycle capacity maintenance rate of the working example, which was subjected to both of the fluorine treatment and the oxygen, treatment, was 87%, and 67% for Comparative Example 1, which was not subjected to the fluorine treatment, and 93% for Comparative Example 2, which was subjected to only the fluorine treatment. That is, the working example has exhibited larger values of the post-100-cycle capacity maintenance rate than Comparative Example 1 and slightly smaller than Comparative Example 2. Namely, the working example has exhibited good cycle characteristics.

From the foregoing results, it can be said that in the working example, the fluorine in the fluorine-oxygen-containing active material layer coating the surface of the positive electrode active material lithium cobaltate (LiCoO₂) restrained the deterioration of the positive electrode active material caused by the reaction with the electrolyte solution and the like, and therefore improved the cycle characteristics, and the fluorine and the oxygen in the fluorine-oxygen-containing active material layer coating the positive electrode active material lithium cobaltate (LiCoO₂) surface served paths of electron conduction, and therefore improved the electron conductivity and lessened the internal resistance of the battery and the like, and achieved sufficient conduction of lithium ions, so that the output characteristics was improved.

1. A method for manufacturing positive electrode active material comprising:
forming a fluorine-based coat film on a surface of a positive electrode active material by subjecting the positive electrode active material to a fluorine treatment; and
forming a fluorine-oxygen-containing active material layer that contains fluorine and oxygen on the surface of the positive electrode active material by firing the fluorine-based coat film under an oxygen atmosphere.

2. The method for manufacturing positive electrode active material according to claim 1, wherein the positive electrode active material containing oxygen is subjected to the fluorine treatment.

3. The method for manufacturing positive electrode active material according to claim 1 or 2, wherein the fluorine-based coat film is subjected to an oxidized fire treatment at a predetermined temperature with an oxidative gas.

4. The method for manufacturing positive electrode active material according to claim 3, wherein the oxidative gas is an oxygen gas that has a partial pressure within a range of 10 to 30%.

5. The method for manufacturing positive electrode active material according to claim 3 or 4, wherein the predetermined temperature is within a range of 600 to 800° C.

6. The method for manufacturing positive electrode active material according to any one of claims 1 to 5, wherein the positive electrode active material is subjected to the fluorine treatment by using a fluorine gas.

7. The method for manufacturing positive electrode active material according to claim wherein a partial pressure of the fluorine gas is within a range of 3 to 7%.

8. The method for manufacturing positive electrode active material according to any one of claims 2 to 7, wherein the positive electrode active material containing oxygen is LiₓMO_{y}, where M represents a transition metal, x is within a range of 0.02 to 2.2, and y is within a range of 1.4 to 3.

9. The method for manufacturing positive electrode active material according to claim 8, wherein the M includes at least one species of Co, Ni and Mn.

10. A positive electrode active material obtained by the method for manufacturing positive electrode active material according to any one of claims 1 to 9.

11. A method for manufacturing lithium secondary battery, comprising forming a positive electrode body with a positive electrode active material obtained by the positive electrode active material manufacture method according to any one of claims 1 to 9.

12. A lithium secondary battery obtained by the method for manufacturing lithium secondary battery according to claim 11.
